(19) United States
(12) Patent Application Publication
(10) Pub. No.: US 2006/0047749 A1
(43) Pub. Date: Mar. 2, 2006

(54) Digital links for multi-media network conferencing

(76) Inventors: Robert Davis, Woodbine, MD (US); Kuriacose Joseph, Gaithersburg, MD (US); Ernest Seah, Germantown, MD (US)

Correspondence Address: THE DIRECTV GROUP, INC.;RE/R11/A109, P.O. Box 956, El Segundo, CA, 90245-0956, US

(21) Appl. No.: 10/930,297

(22) Filed: Aug. 31, 2004

(51) Int. Cl. G06F 15/16

(52) U.S. Cl. 709/204

(57) ABSTRACT

A videoconferencing and data collaboration system is disclosed, wherein user systems exchange A/V data along with other computer data via conferencing devices over a packet network. The conferencing devices are configured to process and transmit A/V data to other devices participating in a conference. Each transmitting conferencing device uses DSP to encode A/V for transmission to the packet network. Once A/V data using the DSP is received, each receiving conferencing device decodes the A/V data and forwards it to a respective terminal for viewing via the digital link. The conferencing devices also share computer data and files over the digital network, where user modifications are tracked by transmitting short messages that indicate key depression or mouse movement.

The present invention relates to network conferencing and more specifically to data collaboration videoconferencing on processor-based packet networks.

### BACKGROUND OF THE INVENTION

Present data collaboration networks, such as IP-based networks, require the mixing of video data with other types of content (e.g., audio data, application data, etc.) from a computer terminal so that a group of geographically diverse terminals may share in the viewing and processing of distributed content. Current generations of data collaboration products require the use of proprietary software applications running on a personal computer (PC) in order to share data, with a hardware or software videoconferencing client dedicated to providing video content.

One example of such videoconferencing systems, using a software-based client, is Microsoft's Netmeeting™, which uses a analog video capture card or a high-speed digital interface to import video data from an external camera to a PC. The imported video data can then be overlaid with local applications, such as Microsoft Office™ to be displayed on a desktop monitor. However, such videoconferencing systems suffer from reduced video quality, since the software-based clients do not typically have the processing power to encode high-quality video in real time.

When using hardware-based systems, the conferencing devices typically used either do not have means to facilitate data collaboration (such as the Starback Torrent VCG™), or use an analog audio/video (A/V) capture card on a PC to import analog audio and video from the conferencing device to the PC collaboration client. For example, the capture card of such systems typically performs analog to digital (A/D) conversion, and imports video over a dedicated network that complies with National Television Standards Committee (NTSC) or Phase Alternate Line (PAL) standards. While these types systems are effective for delivering A/V between terminals, repeated A/D conversion tends to introduce data errors, which in turn degrade the quality of A/V transmission. Furthermore, by requiring a separate network connection, conventional hardware-based systems introduce additional complexity in the synchronizing of data between the conferencing device and the PC.

FIG. 1 illustrates a conventional videoconferencing system 100 that provides PC-based content with overlaid teleconferencing A/V data from the conferencing device to a PC monitor 103. Raw A/V data representing the PC content is transmitted from a video source 101 in a RGB-compatible format to a conferencing device 102. A unique color or chroma key is transmitted in the output of 101, and is used in a video buffer (not shown) of conferencing device 102 to prescribe regions where video content from the conferencing device is to be displayed and overlaid on the PC content. After video is processed in conferencing device 102, the video is processed for RGB conversion if required. The RGB conversion allows the video to be seen easily on standard RGB monitors, which are typically located at the PC monitor 103. This approach allows the video conference and the data-collaboration session to be viewed at the same time on monitor 103.

One problem with the configuration of FIG. 1 is that video control within the conferencing device 102 requires chroma-key detection and support for high-resolution inputs and displays without user intervention. Also, the high data rates present in high-resolution video, and high refresh rates in the graphic cards (not show) make implementation of such systems prohibitively costly. Furthermore, repeated conversions between the analog and digital domains can contribute to quality loss in the resulting transmissions.

FIG. 2 illustrates another conventional videoconferencing system 200 that is known in the art. Under the configuration of FIG. 2, A/V data is transmitted to conferencing device 201, where the conferencing device 201 would decode and transmit the video in a NTSC/PAL format to a video capture card 202 that is typically coupled to a dedicated processing unit 203 (also referred to as a “PC collaboration client”). The processing unit then displays the video received on the PC monitor 204. In this scenario, the PC is responsible for creating a videoconferencing “window” along with the data collaboration content.

One problem with the configuration of FIG. 2 is that the hardware incompatibilities often exist in different processing unit 203 platforms. It follows that the use of different platforms, along with the associated video capture cards, can introduce significant variations in system configuration and cost. Furthermore, different hardware platforms further require the installation of proprietary software drivers. And similar to the configuration in FIG. 1, repeated conversions between the analog and digital domains can contribute to quality loss in the resulting transmissions.

Technologies such as FireWire™ and i-Link™ provide efficient transfer of A/V data. However platforms with these interfaces are not designed to support data collaboration and teleconferencing features. Other devices perform streaming multicasts of videoconferencing sessions over an enterprise LAN to PC's, but those devices do not include the videoconferencing endpoint functionality. Furthermore, these devices do not avail themselves of high-speed digital interfaces for transmission to PC clients using a unified display.

### SUMMARY OF THE INVENTION

A videoconferencing and data collaboration system is disclosed, wherein user systems exchange A/V data, along with other computer data, via conferencing devices connected digitally to a packet network. The conferencing devices are configured to process and transmit A/V data to other devices participating in a conference. Each transmitting conferencing device incorporates a DSP or equivalent hardware to encode A/V data for transmission the packet network. Furthermore, once A/V data is received from the network, each receiving conferencing device decodes the A/V data and forwards it to a respective terminal for viewing. The conferencing devices also share computer data and files over the digital network, where user modifications are tracked by transmitting short messages that indicate key depression or mouse movement.

Since the conferencing device is responsible for decoding the received A/V data from the network, the attached processing terminal is relieved from performing CODEC processing. Also, the digital links used in the system obviate the need for performing extraneous conversion between the analog and digital domains, thus resulting in better quality of A/V data. Furthermore, since digital links come as standard interfaces in modem PCs, availability and support problems are minimized.

Additional features and advantages of the present invention are described in, and will be apparent from, the following Detailed Description of the Invention and the figures.

### BRIEF DESCRIPTION OF THE FIGURES

FIG. 1 illustrates a prior art system that overlays A/V data and PC-based content;

FIG. 2 illustrates another prior art system that uses a PC capture card for transmitting A/V data.

FIG. 3 illustrates a videoconferencing system using digital links under a first embodiment of the invention;

FIG. 3A illustrates an exemplary portion of a conferencing device used in the embodiment of FIG. 3; and

FIG. 3B illustrates a portion of the T.120 data block used in the conferencing device in FIG. 3A.

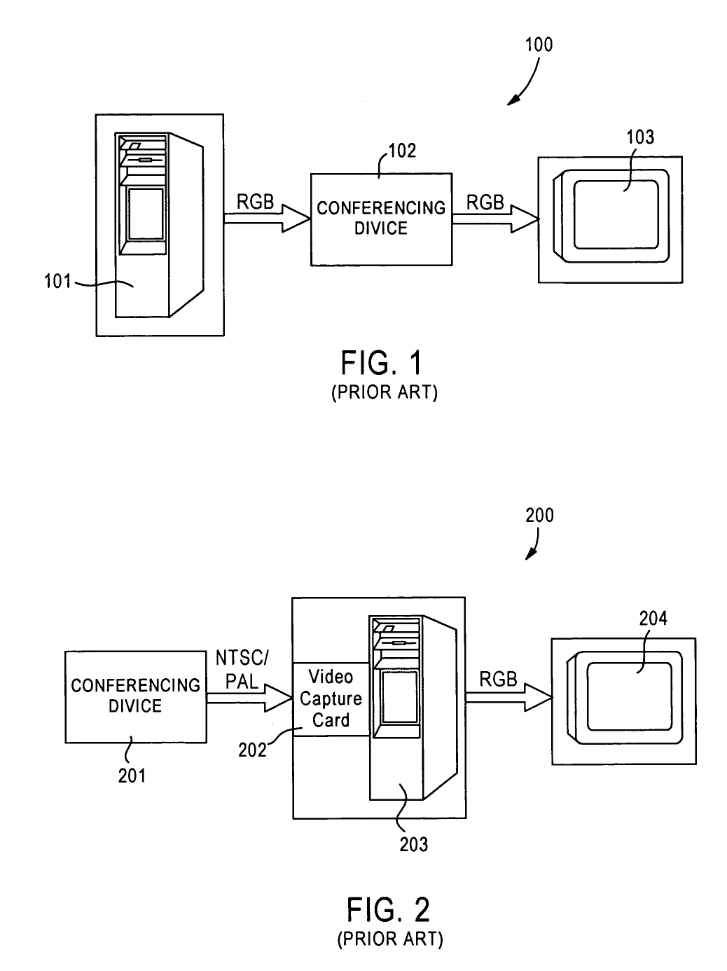

### DETAILED DESCRIPTION OF THE INVENTION

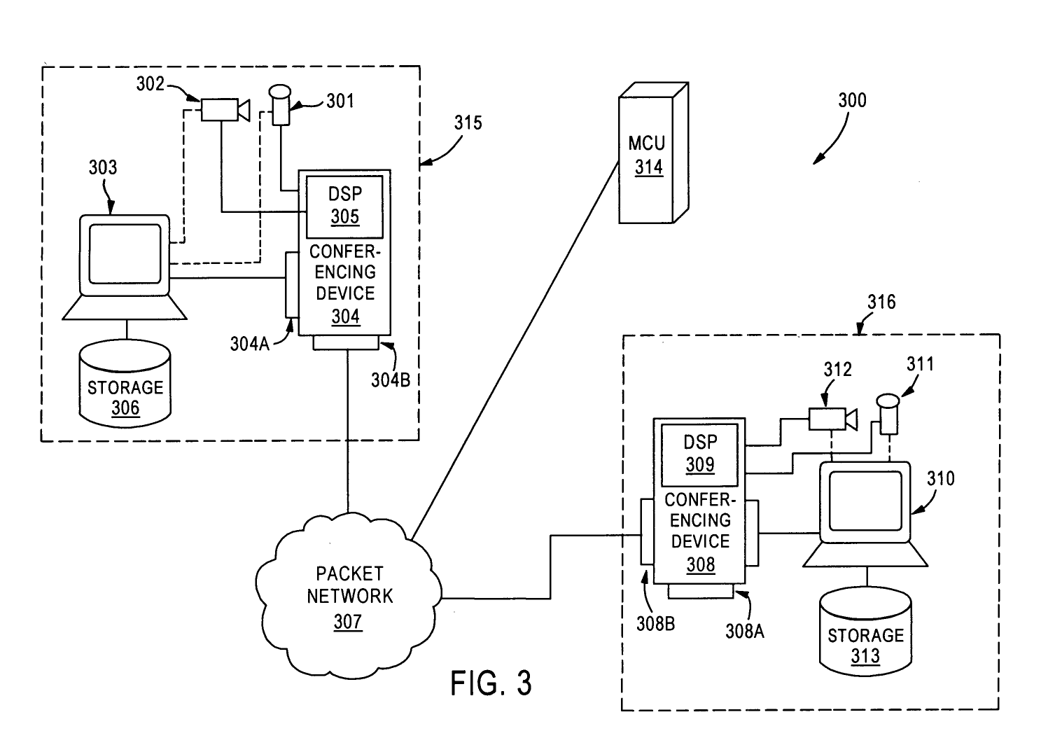

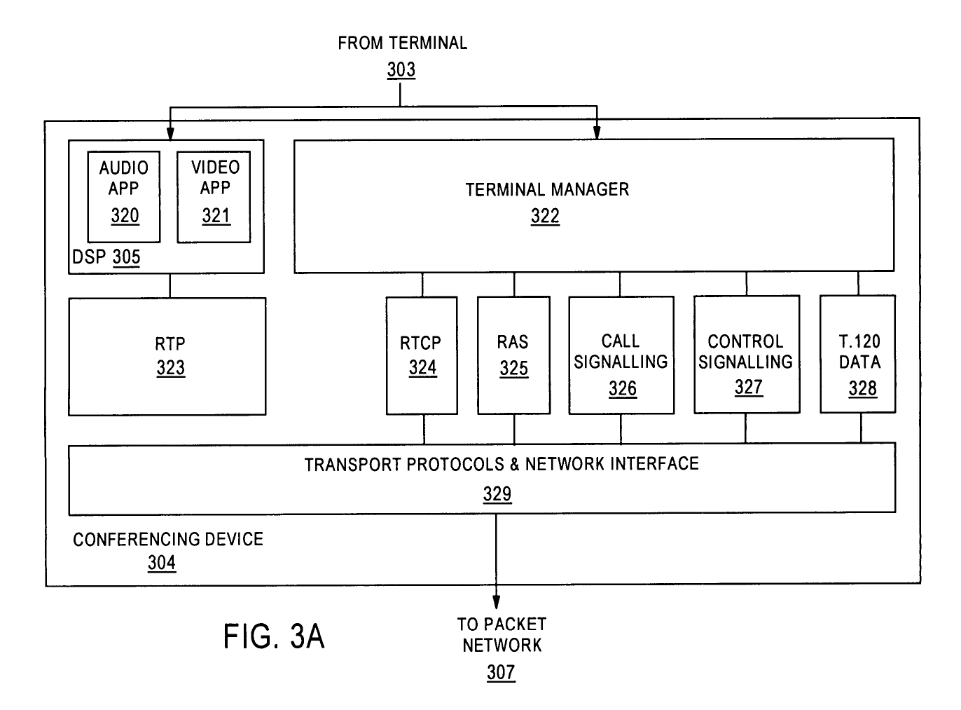

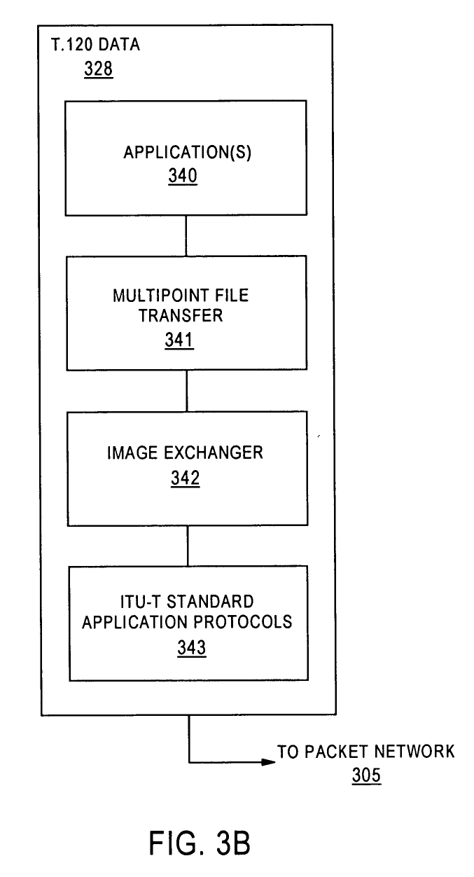

FIG. 3 illustrates a videoconferencing and data collaboration system 300 under a first embodiment of the invention. System 300 shows a videoconferencing and data collaboration topology, where a first user system 315 communicates through a packet network 307 to a second user system 316 via network interface module 304B. A multipoint controller unit (MCU) 314 is coupled to the packet network 307. While the illustration in FIG. 3 discloses only two user systems (315, 316), it should be appreciated by those skilled in the art that three or more user systems may be coupled to the packet network 307 without deviating from the spirit and scope of the invention.

The first user system 315 includes a first processing terminal 303, which is coupled to a storage unit 306. Storage unit 306 may be a hard drive, a removable drive, recordable disk, or any other suitable medium capable of storing computer and A/V data. Terminal 303 is further connected to a conferencing device 304, via digital interface 304A. Conferencing device 304 incorporates a digital signal processor (DSP) 305. As shown in FIG. 3, conferencing device 304 is coupled to an audio source 301 (e.g., microphone) and a video source 302 (e.g., video camera). As can be appreciated by those skilled in the art, devices systems 315 and 316 in the exemplary embodiment may be configured as physically separate devices, a single integrated device, or some combination of both, or that the DSP can be substituted by a dedicated piece of hardware serving the same function.

The second user system 316 includes devices 308-313, which are equivalent to devices 301-306 described above in the first user system (315). The second user system includes a conferencing device 308 with digital interface 308A and network interface module 304B, DSP 309, processing terminal 310, audio source 311, video source 312 and storage unit 313 as shown in FIG. 3.

Under a preferred embodiment, processing terminals 303, 310 provide real-time bidirectional multimedia and data communication through their respective conferencing device 304, 308 to packet network 307. Terminals 303, 310 can either be a PC, or a stand-alone device capable of supporting multimedia applications (i.e., audio, video, data). Packet network 307 may be an IP-based network, Internet packet exchange (IPX)—based local area network (LAN), enterprise network (EN), metropolitan-area network (MAN), wide-area network (WANs) or any other suitable network. A MCU 314 may also be coupled to packet network 307 for providing support for conferences of three or more user systems. Under this condition, all user systems participating in a conference would establish a connection with the MCU 314. The MCU would then be responsible for managing conference resources, negotiation between user systems for determining the audio or video coder/decoder (CODEC) to use, and may also handle the media stream being transmitted over packet network 307.

To illustrate an example of A/V data communicating over system 300, terminal 303 receives A/V data from audio source 301 and video source 302. Alternately, terminal may also receive A/V data, as well as computer data, transmitted from storage device 306. Once the data is received at terminal 303, the data is forwarded via digital link to conferencing device 304. Conferencing device 304 then captures the A/V data and encodes it using DSP 305. Once encoded, the A/V data is transmitted through packet network 307 to either the MCU 314 (if three or more user systems are being used), or directly to conferencing device 308. If the A/V data is received directly at conferencing device 308, the encoded A/V data is then decoded and transmitted to terminal 310 for viewing in a compatible format. If the A/V data is transmitted to MCU 314, the MCU 314 uses conventional methods known in the art to manage and transmit the A/V data to the destination conferencing devices, where the data is decoded in the conferencing device and further transmitted to each respective terminal for viewing. A/V data may include uncompressed digital video (e.g., CCIR601, CCIR656, etc.) or any compressed digital video formats that support streaming (e.g., H.261, H.263, H.264, MPEG1, MPEG2, MPEG4, RealMedia™, Quicktime™). The audio data may be transmitted in half-duplex or full-duplex mode.

One advantage of the system 300 shown in FIG. 3 is that each conferencing device and associated DSP relieves the processing burden that is experienced on most conventional PCs when transmitting and receiving A/V data during videoconferencing. In the exemplary embodiment of the invention, since the conferencing device is responsible for encoding the received A/V data, the sending terminal merely forwards the received A/V data without performing any encoding. Similarly, the receiving terminal only has to decode the received data from the conferencing device to make it available for viewing at terminal 303. And since digital links are being used, there is no extraneous conversion between the analog and digital domains, thus resulting in better quality. The digital link also provides dedicated bandwidth in some cases, and hence does not suffer performance issues, such as arbitration latency, that arise in shared mediums. Furthermore, since digital links, such as Ethernet or USB 2.0 come as standard interfaces in modern PCs, availability and support problems are minimized.

System 300 also provides for the receiving and transmitting of documents separately from, or concurrently with transmitted A/V data. As an example, a document stored in storage medium 306 of a first user system 315 is opened in terminal 303 and is transmitted, to conferencing device 304, where the document is processed under a file transfer protocol (FTP) for transmission to packet network 307. The processing is done preferably under the multipoint file transfer protocol block of the T.120 portion of conferencing device 304, which will be explained in further detail below. After transmission from conferencing device 304, the second user system 316 receives the document in the conferencing device 308 via packet network 307. Conferencing device 308 would then forward the document to terminal 310, where the document would be viewed. Under an alternate embodiment, MCU 314 would forward the document to each respective conferencing device participating in the conference, if three or more users are participating.

To provide users with the ability to manipulate documents (or A/V data) without taking up unnecessary bandwidth, short data messages (also known as “collaboration cues”) are preferably transmitted when a user has depressed a key or has moved a mouse or other device. Any change a local user makes is then replicated on all remote copies of the same document in accordance with the collaboration cue that is received. Under this configuration, the system does not have to re-transmit multiple graphic copies of a document each time it is altered. If chair control is desired, a token mechanism may be used in the system to allow users to take and pass chair control. The specific processes regarding chair control and token mechanisms are described in greater detail in the International Telecommunications Union (ITU) T.120 standard, particularly in T.122 and T.125. Furthermore, a software plug-in may be used in the conferencing devices to recognize RTP streams, which will be discussed in further detail below.

FIG. 3A describes in greater detail a preferred conferencing device configuration that is used for transmitting and receiving A/V and computer data in the embodiment of FIG. 3. While the description in FIG. 3A refers specifically to conferencing device 304 and DSP 305, it should be understood that the configuration is equally applicable to conferencing device 308 and DSP 309, or any other conferencing device used in system 300. Furthermore, while the example of FIG. 3A describes the transmission of A/V data, the same components function to process A/V data received from packet network 307 and will only be discussed briefly.

Conferencing device 304 receives A/V data, as well as computer data from terminal 303, where audio data is received at the audio application portion 320, video data is received at the video application portion 321, and other data, including computer data is received at the terminal manager portion 322 of conferencing device 304. A/V data transmitted from terminal 303 in user system 315 is received at DSP portion 305, which comprises an audio application portion 320 and video application portion 321 as shown in FIG. 3A. Audio application portion 320 provides audio CODEC support and further processes audio signals received from terminal 303 (via audio source 301) as well as audio signals received from remote terminals (from packet network 307) during conferencing. Likewise, video application portion 321 provides video CODEC support for encoding/decoding video received from terminal 303 (via video source 302) for transmission. The audio and video CODECs define the format of audio and video information and represent the way audio and video are compressed (if compression is used) and transmitted over the network. Video application portion 321 also provides decompression capabilities for video under a preferred embodiment.

Once the A/V data is processed, DSP 305 forwards the encoded data to real-time transport protocol portion (RTP) 323. RTP portion 323 manages end-to-end delivery services of real-time audio and video. RTP 323 is typically used to transport data via the user datagram protocol (UDP). Under this configuration, transport-protocol functionality is established among various conferencing devices during conferencing, and is further managed by the transport protocols & network interface 329 as shown in FIG. 3A.

Still referring to FIG. 3A, computer and control data is received at terminal manager 322. Terminal manager 322 controls connectivity and compatibility between terminals engaged in a conference. Real-time transport control protocol (RTCP) portion 324 provides the primary control services and functions as a counterpart to RTP portion 323 described above. The primary function of RTCP portion 324 is to provide feedback on the quality of data distribution. Other RTCP functions include carrying a transport-level identifier for an RTP source, which is used by terminals to synchronize audio and video.

The registration, admission, and status (RAS) portion 325 establishes protocol for the session between endpoints (e.g., terminals in a user system, gateways). More specifically, RAS 325 may be used to perform registration, admission control, bandwidth changes, status, and disengagement procedures between endpoints. A RAS channel is preferably used to exchange RAS messages, and this signaling channel may also be opened between an endpoint and any gatekeeper prior to the establishment of any other channels.

Call signaling portion 326 of FIG. 3B is used to establish a connection between two terminals in a user system. The connection is preferably achieved by exchanging protocol messages (e.g., H.225) on a call signaling channel. The signaling channel is opened between two endpoints, or between an endpoint and a gatekeeper. Control signaling portion 327 is used to exchange end-to-end control messages governing the operation or the endpoint user system terminal. The control messages preferably carry information related to capabilities exchange, opening and closing of logical channels used to carry media streams, flow control messages, and general comments and indications.

The T.120 data portion 328 is based on the ITU-T.120 standard, which is generally made up of a suite of communication and application protocols developed and approved by the international computer and telecommunications industries. The T.120 data portion 328 in FIG. 3B can be enabled to make connections, transmit and receive data, and collaborate using compatible data conferencing features, such as program sharing, whiteboard conferencing, and file transfer.

FIG. 3B illustrates an exemplary segment of the T.120 portion 328 architecture discussed above. The architecture is generally based on the Open Systems Interconnection (OSI) reference model. These protocols are used to develop data-networking protocols and other standards that facilitate multivendor equipment interoperability. The applications segment 340 is comprised of higher level application protocols, which are preferably T.120 compliant. Protocols that are defined for each conferencing device in system 300 would be established in each applications segment 340.

Multi-point file transfer segment 341 defines how files are transferred simultaneously among conference participants. Multi-point file transfer segment would preferably be based on the T.127 standard and would enable one or more files to be selected and transmitted in compressed or uncompressed form to all selected participants during a conference. The image exchanger segment 342 would specify how an application from 340 sends and receives whiteboard information, in either compressed or uncompressed form, for viewing and updating among multiple conference participants. The image exchanger segment 342 is preferably based on the T.126 standard. The ITU-T standard application protocol segment 343 provides lower-level networking protocols for connecting and transmitting data, and specifies interaction with higher level application protocols generated from applications segment 340. The data is then transmitted to packet network 305 as shown in FIG. 3B. While not shown, packet network 305 may further contain a generic application template (based on T.121), multipoint communication services (based on T.122/125) and network specific transport protocols (based on T.123).

While the invention has been described in detail in connection with preferred embodiments known at the time, it should be readily understood that the invention is not limited to the disclosed embodiments. Rather, the invention can be modified to incorporate any number of variations, alterations, substitutions or equivalent arrangements not heretofore described, but which are commensurate with the spirit and scope of the invention.

For example, although the invention has been described in connection over a generic digital link, the invention may be practiced with many types of digital links such as a USB 2.0, IEEE 1394 and even wired or wireless LAN without departing from the spirit and scope of the invention. In addition, although the invention is described in connection with videoconferencing and data collaboration, it should be readily apparent that the invention may be practiced with any type of collaborative network. It is also understood that the device portions and segments described in the embodiments above can substituted with equivalent devices to perform the disclosed methods and processes. Accordingly, the invention is not limited by the foregoing description or drawings, but is only limited by the scope of the appended claims.

The invention is claimed as follows:

1. A method for receiving data during conferencing, said method comprising the steps of:
receiving streamed digital A/V data from a packet network at a conferencing device;
processing digital A/V data in the conferencing device; and
transmitting processed digital A/V data to a computer terminal, wherein the computer terminal displays the processed digital A/V data for viewing.

2. The method of claim 1, wherein said processed digital A/V data is transmitted via a unicast transmission.

3. The method of claim 2, wherein the step of processing digital A/V data in the conferencing device further comprises compression/decompression processing.

4. The method of claim 3, wherein the step of receiving digital A/V data further comprises receiving computer data along with said A/V data.

5. The method of claim 4, wherein the step of processing digital A/V data further comprises processing collaboration cue data.

6. A computer conferencing system, comprising:
a conferencing device;
a computer terminal, said terminal being coupled to said conferencing device;
a network interface module, coupled to said conferencing device, for receiving streamed digital A/V data from a packet network;
a digital signal processor, coupled to said conferencing device, for processing digital A/V data; and
a digital interface, coupled to said conferencing device, for transmitting processed digital A/V data to a computer terminal via a digital link, wherein the computer terminal displays the processed digital A/V data for viewing.

7. The system of claim 6, wherein said processed digital A/V data is transmitted via a unicast transmission.

8. The system of claim 6, wherein the digital signal processor performs compression/decompression processing on the received A/V data.

9. The system of claim 8, wherein the network interface module receives computer data along with said A/V data.

10. The system of claim 9, wherein the network interface module receives collaboration cue data and forwards to the computer terminal.

11. A method for processing A/V and computer data during a network conference, comprising:
capturing streamed digital A/V data in a dedicated hardware processor, said A/V data being captured over a digital link;
processing the A/V data;
receiving computer data in a dedicated hardware processor, said computer data being received over the digital link;
receiving collaboration cue data, wherein the collaboration cue data controls the processed computer data and A/V data; and
transmitting the processed A/V data, computer data and collaboration cue data to a computer terminal.

12. The method of claim 11, wherein said A/V data is captured at the dedicated hardware processor via a digital link in a unicast transmission.

13. The method of claim 12, wherein said computer data and collaboration cue data is received at the dedicated hardware processor via a digital link.

14. The method of claim 13, wherein the step of processing A/V data further comprises processing CODEC data present within said digital A/V data.

15. The method of claim 14, wherein the step of processing digital A/V data further comprises compression/decompression processing.

16. The method of claim 14, wherein the CODEC data comprises one of CCIR601 and CCIR656 uncompressed digital video

17. The method of claim 15, wherein the CODEC data comprises one of H.261, H.263, H.264, MPEG-1, MPEG-2, MPEG-4, RealMedia™, Quicktime™, and Windows Media Video™.

18. A computer conferencing system, comprising:
a computer terminal, said computer terminal transmitting digital A/V data;
a conferencing device, said conferencing device being coupled to said computer terminal via a digital interface and receiving said digital A/V data from the computer terminal via a digital link;
a digital signal processor, coupled to said conferencing device, for processing digital A/V data; and
a network interface module, coupled to said conferencing device, for transmitting streamed digital A/V data to a packet network;

19. The system of claim 18, wherein said digital A/V data is transmitted via a unicast transmission.

20. The system of claim 18, wherein the digital signal processor processes CODEC data present within said digital A/V data.

21. The system of claim 20, wherein the digital signal processor performs compression/decompression processing on the received A/V data.

22. The system of claim 21, wherein the network computer terminal transmits computer data along with said A/V data.

23. The system of claim 22, wherein the computer terminal transmits collaboration cue data along with said A/V data.
